(19) United States
(12) Patent Application Publication
(10) Pub. No.: US 2026/0162551 A1
(43) Pub. Date: Jun. 11, 2026

(54) SYSTEMS AND METHODS TO GENERATE PERSONALIZED LESSON CONTENT BASED ON USER CONTENT PREFERENCES

(71) Applicant: Disney Enterprises, Inc., BURBANK, CA (US)

(72) Inventors: Malcolm E. Murdock, Burbank, CA (US); Alif Khalfan, Redwood City, CA (US)

(21) Appl. No.: 18/975,234

(22) Filed: Dec. 10, 2024

(51) Int. Cl. G09B 5/06; G06Q 50/20; G09B 5/02; G09B 5/04

(52) U.S. Cl. CPC G09B 5/065; G06Q 50/20; G09B 5/02; G09B 5/04

(57) ABSTRACT

Systems and methods to generate personalized lesson content based on user content preferences are described herein. Exemplary implementations: stores user preference information for individual users; stores vectorized content belonging to one or more bodies of content; provide an assessment to a first user; receive a response to the assessment from the first user; identify one or more skills that require improvement based on the response; provide at least the one or more skills and the first preference information as input to a machine-learning model; provide one or more prompts to the machine-learning model that configure the machine-learning model to obtain vectorized content and generate first lesson content based on the obtained vectorized content, the first lesson content being generated to facilitate improvements to the one or more skills; obtain the first lesson content from the machine-learning model; and provide the first lesson content to the first user.

### FIELD OF THE DISCLOSURE

The field of this disclosure includes generative artificial intelligence for dynamically generating educational content.

### BACKGROUND

Programs and application for language learning and development are known. Many of these are designed for children and may offer standardized lessons based on the child's age. The lessons often focus on improving reading, reading comprehension, writing, speaking, and math skills. While these lessons may be effective for many learners, the lack of personalization and customization limits the effectiveness for a wider range of users.

### SUMMARY OF THE INVENTION

System(s) and method(s) to generate personalized lesson content based on user content preferences are described herein. User content preferences may identify types and kinds of content typically enjoyed by users. The content preferences may be determined based on user activity and interaction across a plurality of applications and/or platforms. The system(s) and method(s) may utilize the content preferences of users to generate customized lesson content that includes the content typically enjoyed by the users and/or similar content. Additionally, the lesson content may be customized to target specific skills of which the particular users require improvement. The result is lesson content that enhances learning by identifying and targeting specific skills, while incorporating content users enjoy to promote engagement.

The system may include one or more hardware processors configured by machine-readable instructions, electronic storage, a vectorized content repository, and/or other components. Executing the machine-readable instructions may cause the one or more hardware processors to generate personalized lesson content based on user content preferences. The machine-readable instructions may include one or more instruction components. The instruction components may include computer program components. The instruction components may include one or more of an assessment component, a model component, a user interface component, and/or other instruction components.

The electronic storage may store preference information for individual users. The user preference information may specify one or more bodies of content preferred by the individual users. The preference information may include first preference information for a first user specifying a first body of content.

The vectorized content repository may store vectorized content belonging to the one or more bodies of content, wherein individual bodies of content may include vectorized content sharing one or more characteristics, and wherein the vectorized content includes vectorized representations of one or more of text content, image content, video content, and audio content.

The assessment component may be configured to provide an assessment to the first user.

The assessment component may be configured to receive a response to the assessment from the first user.

The assessment component may be configured to identify one or more skills that require improvement based on the response.

The model component may be configured to provide one or more of the one or more skills, the first preference information, and/or other information as input to a machine-learning model.

The model component may be configured to provide one or more prompts to the machine-learning model. The prompts may configure the machine-learning model to obtain vectorized content from the vectorized content repository in accordance with the first preference information. The obtained vectorized content may belong to the first body of content. The prompts may configure the machine-learning model to generate first lesson content based on one or more of the obtained vectorized content belonging to the first body of content, the one or more skills, and/or other information. The first lesson content may be generated to facilitate improvements to the one or more skills by the first user, responsive to the first user engaging with the first lesson content.

The model component may be configured to obtain output from the machine-learning model. The output may include the first lesson content.

The user interface component may be configured to provide the first lesson content to the first user.

As used herein, any association (or relation, or reflection, or indication, or correspondency) involving servers, processors, client computing platforms, and/or another entity or object that interacts with any part of the system and/or plays a part in the operation of the system, may be a one-to-one association, a one-to-many association, a many-to-one association, and/or a many-to-many association or N-to-M association (note that N and M may be different numbers greater than 1).

These and other features, and characteristics of the present technology, as well as the methods of operation and functions of the related elements of structure and the combination of parts will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a,’ ‘an,’ and ‘the’ include plural referents unless the context clearly dictates otherwise.

### BRIEF DESCRIPTION OF THE DRAWINGS

FIG. 1 illustrates a system configured to generate personalized lesson content based on user content preferences, in accordance with one or more implementations.

FIG. 2 illustrates a method to generate personalized lesson content based on user content preferences, in accordance with one or more implementations.

FIG. 3A illustrates an exemplary implementation of the system configured to generate personalized lesson content based on user content preferences, in accordance with one or more implementations.

FIG. 3B illustrates an exemplary implementation of the system configured to generate personalized lesson content based on user content preferences, in accordance with one or more implementations.

### DETAILED DESCRIPTION

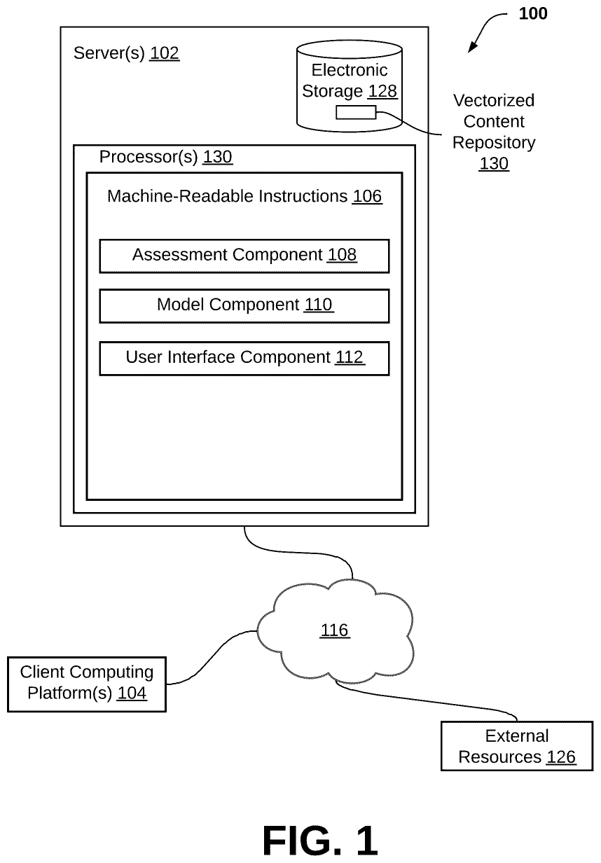

FIG. 1 illustrates a system 100 configured to generate personalized lesson content based on user content preferences, in accordance with one or more implementations. In some implementations, system 100 may include one or more servers 102. Server(s) 102 may include electronic storage 128, one or more processors 130, and/or other components. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction components. The instruction components may include computer program components. The instruction components may include one or more of assessment component 108, model component 110, user interface component 112, and/or other instruction components.

Electronic storage 128 may store preference information for individual users. The user preference information may specify one or more bodies of content preferred by the individual users. In some implementations, the user preference information for the individual users may be based on user activity, by the individual users, within one or more applications and/or platforms. The applications and/or platforms may be third-party platforms. The applications and/or platforms may facilitate user interactions with content. The user interaction with the content of the applications and/or platforms may be active interaction (e.g., playing games) and/or passive interaction (e.g. watching movies, listening to music, etc.).

By way of non-limiting illustration, the one or more applications may include a content streaming application. In some implementations, the system may be configured to obtain streaming history associated with particular users, identifying content streamed by the particular users. A first user may stream content within the content streaming application. First streaming history identifying content streamed by the first user may be obtained from the content streaming application. The first streaming history may identify shows, movies, music, and/or other types of content streamed by the first user within the content streaming application. In some implementations, first preference information may be determined based on the first streaming history. For example, bodies of content preferred by the first user may be determined based on the content streamed by the first user, characteristics of the content streamed by the first user, and/or other information.

In some implementations, preference information for individual users may be based on real-world experiences of the individual users. The real-world experiences may include attending events, attending themed days/nights, attending shows, consuming and/or purchasing food, consuming and/or purchasing beverages, meeting and/or capturing photos and/or videos with characters, riding ride attractions, viewing sights, purchasing and/or obtaining consumer items, and/or other real-world experiences that the users may experience, view, encounter, perceive, enjoy, and/or dislike. For example, the events may include concerts, plays, sports games, festivals, tastings, weddings, ceremonies, graduations, holidays (e.g., Halloween, Easter, Christmas, etc.), tree lightings, and/or other events. The themed days/nights may be holiday themed, character themed, movie themed, era themed, and/or other themes. The shows may include light shows, firework shows, parades, music shows, dance shows, character battles, character performances, and/or other shows. The food may include dishes such as entrees, appetizers, desserts, presentations thereof, and/or other dishes the users may have order, consumed, and/or witnessed being made. The food may also or alternatively include snacks including foods that may be consumed while the user is moving or transporting from one location to another. The beverages may include drinks, specialty drinks, containers holding such drinks and specialty drinks, and/or other beverages. The consumer items may include balloons, toys, lanyard pins, the food, the beverages, and/or other consumer items the user may possess and/or purchase.

The real-world experiences may include, involve, and/or otherwise be associated with content. For example, the real-world experiences may include characters from movies, television shows, animations, plays, musicals, and/or works of art. By way of non-limiting illustration, the ride attractions may be themed as one of the movies, the television shows, the animations, the plays, the musicals, and/or other works of art. Riding a ride attraction may indicate the individual users prefer the movie, television show, animation, play, musical and/or other work of art which the ride attraction may be themed as. By way of non-limiting illustration, food, beverages, consumer items, and/or other real-world experiences may be similarly themed as one of the movies, the television shows, the animations, the plays, the musicals, and/or other works of art. In some implementations, system 100 may be configured obtain real-world experience records for individual users that specify the real-world experiences involving the users. The real-world experience records may be obtained from one or more third-party applications that provide, record, track, and/or facilitate the real world-experiences. The application may include web applications, mobile applications, desktop applications, cloud applications and/or other types of applications. By way of non-limiting illustration, the applications may be a theme park companion application, a shopping application, a food delivery and/or pickup application, ticketing application, travel application (e.g., hotels, cruises, etc.), and/or other types of applications. By way of non-limiting illustration, real-world experience records obtained from a theme park companion application may indicate one or more of ride attractions visited by an individual user, a number of times the individual user visited the ride attractions, one or more shows attended by the individual user, one or more character experiences attended by the individual user, and/or other information characterizing real-world experiences experienced by the individual user. Real-world experience records may include a purchase history and/or transaction history indicating one or more goods or services purchased by an individual user within various types of applications. By way of non-limiting illustration, real-world experience records may include a purchase history indicating one or more items purchased by an individual user within a gaming application.

In some implementations, preference information for individual users may be based on user input and/or selection via client computing platform(s) 104 associated with the individual users. The user input and/or selection may be provided in response to one or more prompts presented to the individual users via a user interface of the client computing platform(s) 104. The one or more prompts may include questions designed to determine content preferences of the individual users that respond to the questions. By way of non-limiting illustration, the prompt may ask an individual user to select their favorite movies, favorite genre of movies, favorite shows, favorite characters, and/or other information. In some implementations, one or more selectable user interface elements may be presented with the prompt. The one or more selectable user interface elements may display selectable answers to the prompt. By way of non-limiting illustration, individual ones of the selectable user interface elements may display different movies, genres, shoes, characters, and/or other information the individual user may select in response to the prompt.

In some implementations, the one or more prompts may be presented to the individual users to confirm preference information for the individual users. The one or more prompts may be presented to an individual user responsive to conflicting preferences indicated by preference information for the individual user. By way of non-limiting illustration, preference information for the individual may indicate the user enjoys a first genre of movies and a second genre of movies. The first genre of movies may be different from the second genre of movies (e.g., there may be low audience overlap between the first and second genre of movies). One or more prompts may be presented to the individual user to determine whether the user enjoys both the first genre of movie and the second genre of movies and/or whether the user enjoys the first genre of movies more than the second genre of movies. While genres of movies are recited, this is not intended to be limiting. Conflicting preferences indicated by preference information may be related to shows, themes, characters, and/or other aspects of content.

First preference information may specify a first body of content and/or other bodies on content preferred by the first user. The first preference information may be based on content streamed, downloaded, played, purchased, and/or otherwise interacted with by the first user. The first preference information may also be based on real-world experiences of the first user. By way of non-limiting illustration, streaming history of the first user may indicate the first user streaming movies including a first character. Real-world experience record(s) for the first user may indicate the first user purchasing one or more consumer items themed as the first character and/or the first user visiting a ride attraction or hotel themed as involving the first character. The first preference information may specify a first body of content based on the streaming history and/or real-world experience record(s) of the first user. By way of non-limiting illustration, the first body of content may be defined by the first character and/or the movie involving the first character. For example, content belonging to the first body of content may include, involve, the first character and/or the movie involving the first character and/or content similar to the first character and/or the movie involving the first character.

Vectorized content repository 130 may store vectorized content belonging to the one or more bodies of content. Individual bodies of content may include vectorized content sharing one or more common characteristics, The one or more common characteristics may include themes, styles, genres, stories, movies, shows, or characters of the vectorized content. Theme may relate to the main subject and/or recurring idea present in the vectorized content. For example, themes may include one or more of adventure, friendship, love and relationships, technology, space, nature, and/or other types of themes. Styles may relate to the visual appearance of content (e.g., cartoon, stop motion animation, puppet animation, live-action, comic book, etc.), a writing style of content (e.g., creative, journalistic, poetry, etc.), a music style of content (e.g., pop, jazz, classical, hip-hop, etc.), and/or other types of style. Genre may relate to the form and/or subject matter of content. For example, genres may include fairytales and/or princesses, superheroes, action & adventure, fantasy, science fiction, historical, horror, and/or other genres. By way of non-limiting illustration, a body of content may include vectorized content related to space. A body of content may include vectorized content related to space and adventure. A body of content may include vectorized content related to fairytales and a first movie including a princess character.

In some implementations, vectorized content repository 130 may be a multi-modal repository configured to store content within a high-dimensional vector space. The multi-modal repository may include vectorized text content, vectorized image content, vectorized video content, vectorized audio content, and/or other types of vectorized content. In some implementations, vectorized content repository 130 may identify normalized content associated with the stored vectorized content. By way of non-limiting illustration, a first item of vectorized content stored in vectorized content repository 130 may be a vector representation of a first item of normalized content. The normalized content may be stored in electronic storage 128 or included in external resources 126 and accessed via one or more network(s) 116. In some implementations, an individual body of content may be defined by a region and/or area of the high-dimension vector space such that individual items of vectorized content stored within the region of the vector space may be characterized as belonging to the individual body of content. In some implementations, an individual body of content may be defined by distance from one or more individual items of vectorized content. The distance may be defined by the cosine similarity, Euclidean distance, Manhattan distance, and/or other distance metric between the individual items of vectorized content.

While FIG. 1 shows vectorized content repository 130 as included in electronic storage 128, this is not intended to be limiting. In some implementations, vectorized content repository 130 may include electronic storage media separate from electronic storage 128. In some implementations, vectorized content repository 130 may be a remotely located and/or accessible by system 100 via one or more network(s) 116.

Assessment component 108 may be configured to provide one or more assessments to the first user. The one or more assessments may be provided via a user interface of client computing platform 104 associated with the first user. In some implementations, assessment component 108 may be configured to provide one or more assessments based on user information obtained from the first user. The user information may include one or more of age, educational background, learning goals, and/or other information pertaining to the first user. By way of non-limiting illustration, the educational background of the first user may indicate an educational and/or grade level completed by the user and/or other information. By way of non-limiting illustration, learning goals may indicate the user is seeking to improve reading skills, improve writing skills, learn a new language, improve language proficiency (e.g., conversational, professional, etc.), and/or other learning goals. In some implementations, the one or more assessments may be generated by one or more models (e.g., large language models) based one or more provided inputs. The one or more provided inputs may include the user information obtained from the first user and/or other information such that the one or more generated assessments may be personalized for the first user. In some implementations, the one or more models configured to generate the one or more assessments may be the same as or similar to the one or more models configured to generate lesson content based on provided inputs.

In some implementations, the one or more assessments may be interactive. The one or more assessments may include one or more questions, activities, games, puzzles, surveys, and/or other interactive prompts. By way of non-limiting illustration, the one or more assessments may include presenting a passage followed by a series of questions associated with the passage to assess reading comprehension. The one or more assessments may include a passage followed by a prompt for the user to write (and/or type) a response to assess reading comprehension. Assessment component 108 may be configured to receive responses by the first user to the one or more assessments. In some implementations, the responses by the first user to the one or more assessments may include verbal input, handwritten input, device input, and/or other types of user input. Client computing platform 104 associated with the first user may include one or more sound capturing components (e.g., microphone) for receiving verbal input from the first user. Client computing platform 104 may be a tablet and/or include a touchscreen surface configured to receive handwritten input (i.e., stylus-written). Client computing device 104 may include one or more components for receiving device input (e.g., buttons, switches, keys, etc.).

Assessment component 108 may be configured to identify one or more skills that require improvement based on the responses by the first user to the one or more assessments. In some implementations, assessment component 108 may be configured to determine one or more scores based on the responses by the first user to the one or more assessments. Individual ones of the one or more scores may correspond to individual ones of the one or more skills. Individual ones of the one or more skills may be identified as requiring improvement, responsive to the scores for the individual ones of the one or more skills meeting or exceeding a threshold. The one or more skills are associated with one or more of reading, reading comprehension, writing, speaking, math, and/or other types of skills. By way of non-limiting illustration, the one or more identified skills may include pronunciation, reading speed, summarization, context clues and/or deduction, phonemic awareness, spelling, sentence structure, grammar and/or syntax, vocabulary, and/or other types of skills.

In some implementations, assessment component 108 may be configured to provide the responses by the first user to the one or more assessments to one or more models as input. The one or more models may be configured to generate output based on the provided inputs. The generated outputs may identify the one or more skills that require improvement based on the responses by the first user to the one or more assessments. The one or more models may be the same as or similar to the one or more models configured to generate lesson content based on provided inputs.

Model component 110 may be configured to provide one or more of the one or more skills, the first preference information, and/or other information as input to one or more models. In some implementations, a subset of the one or more skills that require improvement may be provided as input to the one or more models. The subset of the one or more skills may share one or more characteristics and/or features. By way of non-limiting illustration, a first subset may include one or more skills related to reading and writing. A second subset may include one or more skills related to math. In some implementations, all of the one or more skills that require improvement may be provided as input the one or more models. The one or more models may be trained machine-learning models that utilize one or more of an artificial neural network, naïve Bayes classifier algorithm, k-means clustering algorithm, support vector machine algorithm, linear regression, logistic regression, decision trees, random forest, nearest neighbors, and/or other approaches. In some implementations, the one or more models may be incorporated to the generate lesson content on provided inputs. In some implementations, model component 110 may be configured to train the one or more models. Model component 110 may utilize training techniques such as deep learning. Model component 110 may utilize training techniques such as one or more of supervised learning, reinforcement learning, and/or other techniques.

In supervised learning, the model(s) may be provided with a known training dataset that includes desired inputs and outputs, and the model(s) may be configured to find a method to determine how to arrive at those outputs based on the inputs. By way of non-limiting illustration, in order to output lesson content, a model may be trained with training input information comprising skills for improvement, user preference information and/or other information, and training output information comprising exemplary lesson content. The model may identify patterns in information, learn from observations, and/or make predictions. The model may make predictions and may be corrected by an operator - this process may continue until the model achieves a desired level of accuracy/performance. Supervised learning may utilize approaches including one or more of classification, regression, forecasting, and/or other approaches.

Semi-supervised learning may be similar to supervised learning, but instead uses both labelled and unlabeled data. Labelled data may comprise information that has meaningful tags so that the model(s) can understand the data, while unlabeled data may lack that information. By using this combination, the machine-learning model(s) may learn to label unlabeled data.

For unsupervised learning, the machine-learning model(s) may study information to identify patterns. There may be no answer key or human operator to provide instruction. Instead, the model(s) may determine the correlations and relationships by analyzing available information. In an unsupervised learning process, the machine-learning model(s) may be left to interpret large information sets and address that information accordingly. The model(s) may try to organize that information in some way to describe its structure. This might mean grouping the information into clusters or arranging it in a way that looks more organized. Unsupervised learning may use techniques such as clustering and/or dimension reduction.

Reinforcement learning may focus on regimented learning processes, where the machine-learning model(s) may be provided with a set of actions, parameters, and/or end values (e.g., the desired outputs). By defining the rules, the machine-learning model(s) then tries to explore different options and possibilities, monitoring and evaluating each result to determine which one is optimal to generate correspondences. Reinforcement learning teaches the model(s) trial and error. The model(s) may learn from past experiences and adapt its approach in response to the situation to achieve the best possible result.

In some implementations, a plurality of models may be configured to function cooperatively to generate lesson content based on provided inputs. Individual models of the plurality of models may perform specific functions contributing to the generation of lesson content. By way of non-limiting illustration, the plurality of models may include a first machine-learning model, second machine-learning model, a third machine-learning model, and/or other models. The first machine-learning model may be configured to generate one or more lessons based on one or more skills requiring improvement provided as input and/or obtained vectorized content. The second machine-learning model may be configured to generate visual content based on user preference information provided as input and/or vectorized content obtained based on the user preference information. The third machine-learning model may be configured to integrate the one or more lessons and the visual content to generate lesson content. The visual content may include one or more of video content (e.g., animations), image content, audio content, text content, and/or other types of content. It should be noted that the functions described for the first, second, and third machine-learning models are not intended to be limiting. The plurality of models may include one or more other models that are configured to perform one or more other functions to generate lesson content.

Model component 110 may be configured to provide one or more prompts to the one or more machine-learning models. The one or more prompts may include and/or identify the one or more skills, the first preference information, and/or other information provided as input to the one or more machine-learning models. The prompts may configure the one or more models to obtain vectorized content from vectorized content repository 130 in accordance with the first preference information and/or other information. In some implementations, the one or more prompts may include one or more queries for obtaining content from vectorized content repository 130 and/or other content repositories. In some implementations, providing the one or more prompts to the machine-learning model may configure the machine-learning model to obtain content from one or more external repositories in accordance with the first preference information. The one or more external repositories may include vectorized content belonging to the one or more bodies of content. The one or more queries may be provided to the one or more machine-learning models. The obtained vectorized content may belong to the first body of content and/or other bodies of content similar to the first body of content. The prompts may configure the machine-learning model to generate first lesson content based on one or more of the obtained vectorized content belonging to the first body of content, the one or more skills, and/or other information. The first lesson content may be generated to facilitate improvements to the one or more skills by the first user, responsive to the first user engaging with the first lesson content.

Lesson content may include one or more lesson elements. The lesson elements may be one or more of text content, image content, visual content, audio content, and/or other types of content. By way of non-limiting illustration, the lesson elements may include one or more questions, activities, games, puzzles, surveys, and/or other interactive prompts for improving the one or more identified skills. In some implementations, the one or more interactive prompts may include content based on the obtained vectorized content. By way of non-limiting illustration, the first body of content may include vectorized content associated with a first character. The first lesson content may include one or more interactive prompts involving, referring to, and/or depicting the first character. By way of non-limiting illustration, the first body of content may include vectorized content associated with a first animation style. The first lesson content may include content in the first animation style and/or be generated in the first animation style.

User interface component 112 may be configured to provide the first lesson content to the first user. The first lesson content may be presented to the first user via a graphical user interface of a client computing platform 104 associated with the first user. By way of non-limiting illustration, the one or more questions, activities, games, puzzles, surveys, and/or other interactive prompts for improving the one or more identified skills included in the first lesson content may be displayed for the first user. In some implementations, the lesson content may be interactive and/or require user input to progress through the lesson content. In some implementations, the lesson content may be presented for viewing by the first user. For example, the first lesson content may be a video tutorial to be viewed by the first user. The client computing platform 104 may be configured to receive user input indicating the first user engaging with the first lesson content. By way of non-limiting illustration, the user input may include one or more of verbal input, handwritten input, device input, biometric input (e.g. gaze-tracking, head pose tracking, etc.), and/or other types of input.

In some implementations, user interface component 112 may be configured to receive responses by the first user engaging with the first lesson content. Assessment component 108 may be configured to assess improvement of the one or more skills by the first user based on the responses by the first user to the first lesson content. Assessment component 108 may be configured to modify the one or more skills based on the assessment. Model component 110 may be configured to provide the one or more modified skills, the first preference information, and/or other information as input to the machine-learning model. Model component 110 may be configured to provide one or more prompts to the machine-learning model. The one or more prompts may configure the machine-learning model to generate second lesson content based on the obtained vectorized content belonging to the first body of content and the one or more modified skills. The second lesson content may be generated to facilitate improvements to the one or more modified skills by the first user. In some implementations, the second lesson content may be generated based on the first user's engagement with the first lesson content and/or other previously provided lesson content. The first user's engagement with the first lesson content may specify whether the first user they completed the first lesson content, the time taken to do so, the number of incorrect answers, and/or other relevant factors. By way of non-limiting illustration, the first user's engagement with the first lesson content may indicate the first lesson content was highly challenging for the first user. In response, the second lesson content may be generated with a lower level of difficulty. Model component 110 may be configured to obtain output from the machine-learning model. The output may include the second lesson content. User interface component 112 may be configured to provide the second lesson content to the first user.

Referring back to FIG. 1, in some implementations, server(s) 102, client computing platform(s) 104, and/or external resources 126 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 126 may be operatively linked via some other communication media.

A given client computing platform 104 may include one or more processors configured to execute computer program components. The computer program components may be configured to enable an expert or user associated with the given client computing platform 104 to interface with system 100 and/or external resources 126, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 126 may include sources of information outside of system 100, external entities participating with system 100, and/or other resources. In some implementations, some or all of the functionality attributed herein to external resources 126 may be provided by resources included in system 100.

Server(s) 102 may include electronic storage 128, one or more processors 124, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, and/or 112, and/or other components. Processor(s) 130 may be configured to execute components 108, 110, and/or 112, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, and/or 112, are illustrated in FIG. 1 as being implemented within a single processing unit, in implementations in which processor(s) 130 includes multiple processing units, one or more of components 108, 110, and/or 112 may be implemented remotely from the other components. The description of the functionality provided by the different components 108, 110, and/or 112 described below is for illustrative purposes, and is not intended to be limiting, as any of components 108, 110, and/or 112 may provide more or less functionality than is described. For example, one or more of components 108, 110, and/or 112 may be eliminated, and some or all of its functionality may be provided by other ones of components 108, 110, and/or 112. As another example, processor(s) 130 may be configured to execute one or more additional components that may perform some or all of the functionality attributed below to one of components 108, 110, and/or 112.

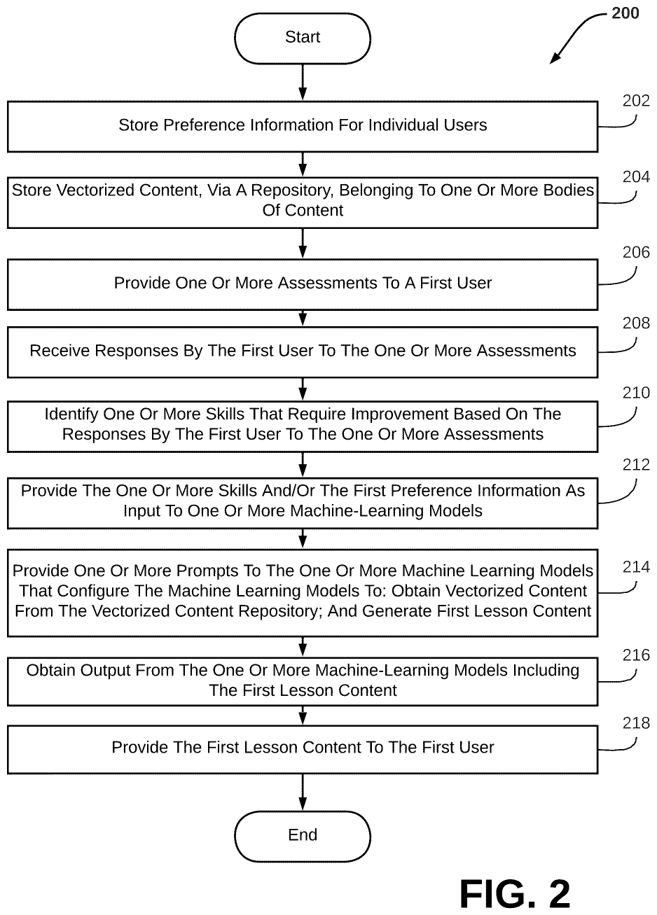

FIG. 2 illustrates a method 200 to generate personalized lesson content based on user content preferences, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include storing preference information for individual users. The user preference information may specify one or more bodies of content preferred by the individual users. The preference information may include first preference information for a first user specifying a first body of content. Operation 202 may be performed by one or more hardware components that is the same as or similar to electronic storage 128, in accordance with one or more implementations.

An operation 204 may include storing, via a vectorized content repository, vectorized content belonging to the one or more bodies of content, wherein individual bodies of content may include vectorized content sharing one or more common characteristics, wherein the one or more common characteristics include themes, styles, genres, stories, or characters of the vectorized content, and wherein the vectorized content includes text content, image content, video content, and audio content. Operation 204 may be performed by one or more hardware components that is the same as or similar to vectorized content repository 130, in accordance with one or more implementations.

An operation 206 may include providing one or more assessments to a first user. Operation 206 may be performed by one or more hardware processors configured by machine-readable instructions including a component that is the same as or similar to assessment component 108, in accordance with one or more implementations.

An operation 208 may include receiving responses by the first user to the one or more assessments. Operation 208 may be performed by one or more hardware processors configured by machine-readable instructions including a component that is the same as or similar to assessment component 108, in accordance with one or more implementations.

An operation 210 may include identifying one or more skills that require improvement based on the responses by the first user to the one or more assessments. The one or more skills are associated with one or more of reading, reading comprehension, writing, speaking, math, and/or other types of skills. Operation 210 may be performed by one or more hardware processors configured by machine-readable instructions including a component that is the same as or similar to assessment component 108, in accordance with one or more implementations.

An operation 212 may include providing one or more of the one or more skills, the first preference information, and/or other information as input to a machine-learning model. Operation 212 may be performed by one or more hardware processors configured by machine-readable instructions including a component that is the same as or similar to model component 110, in accordance with one or more implementations.

An operation 214 may include providing one or more prompts to the machine-learning model. The prompts may configure the machine-learning model to obtain vectorized content from the vectorized content repository in accordance with the first preference information. The obtained vectorized content may belong to the first body of content. The prompts may configure the machine-learning model to generate first lesson content based on one or more of the obtained vectorized content belonging to the first body of content, the one or more skills, and/or other information. The first lesson content may be generated to facilitate improvements to the one or more skills by the first user, responsive to the first user engaging with the first lesson content. Operation 214 may be performed by one or more hardware processors configured by machine-readable instructions including a component that is the same as or similar to model component 110, in accordance with one or more implementations.

An operation 216 may include obtaining output from the machine-learning model. The output may include the first lesson content. Operation 216 may be performed by one or more hardware processors configured by machine-readable instructions including a component that is the same as or similar to model component 110, in accordance with one or more implementations.

An operation 218 may include providing the first lesson content to the first user. Operation 218 may be performed by one or more hardware processors configured by machine-readable instructions including a component that is the same as or similar to user interface component 112, in accordance with one or more implementations.

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “generate” (and derivatives thereof) may include measure, calculate, compute, estimate, approximate, determine, and/or otherwise derive, and/or any combination thereof.

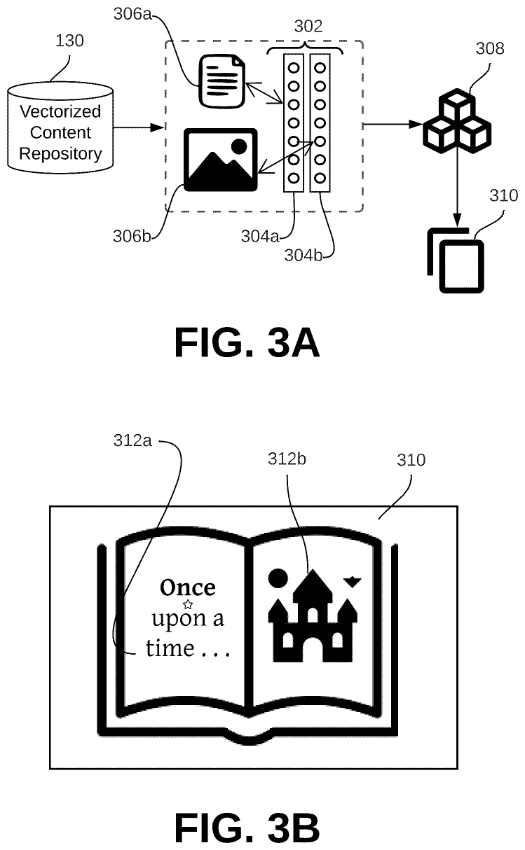

FIGS. 3A-3B illustrates an exemplary implementation of a system to generate personalized lesson content based on user content preferences, in accordance with one or more implementations. Referring to FIGS. 1 and 3A, vectorized content belonging to a first body of content 302 may be obtained from vectorized content repository 130. A first item of vectorized content 304a and a second item of vectorized content 304b belong to the first body of content 302. First item of vectorized content 304a and second item of vectorized content 304b may share one or more common characteristics. The one or more common characteristics may define and/or be associated with first body of content 302. In some implementations, first item of vectorized content 304a may be a vectorized embedding of first content 306a. Second item of vectorized content 304b may be a vectorized embedding of second content 306b. First content 306a and second content 306b may be normalized content and/or stored in electronic storage media (the same as or similar to electronic storage 128 illustrated in FIG. 1) separate from vectorized content repository 130. First body of content 302 may be provided to and/or obtained by one or more models 308. One or more models 308 may be the same as or similar to the one or more models for generating lesson content used by system 100 (e.g., shown in FIG. 1). One or more models 308 may generate first lesson content 310 based on the first body of content 302 and/or other provided inputs.

FIG. 3B illustrates first lesson content 310 presented to a first user. First lesson content 310 may be presented to the first user on a graphical user interface of a client computing platform associated with the first user. First lesson content 312 may include one or more lesson elements 312a, 312b and/or other elements. By way of non-limiting illustration, the one or more lesson elements 312a, 312b may be determined based on preference information for the first user. For example, first lesson element 312a may be based on and/or otherwise pertain to first content 306a. Second lesson element 312b may be based on and/or otherwise pertain to second content 306b.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed:

1. A system configured to generate personalized lesson content based on user content preferences, the system comprising:
electronic storage that stores user preference information for individual users, wherein the user preference information specifies one or more bodies of content preferred by the individual users, and wherein the user preference information includes first preference information for a first user specifying a first body of content;
a vectorized content repository that stores vectorized content belonging to the one or more bodies of content, wherein individual bodies of content include vectorized content sharing one or more characteristics, and wherein the vectorized content includes vectorized representations of text content, image content, video content, audio content, or a combination thereof;
one or more physical processors configured by machine-readable instructions to:
provide an assessment to the first user;
receive a response to the assessment from the first user;
identify one or more skills that require improvement based on the response;
provide at least one of the one or more skills and the first preference information as input to a machine-learning model;
provide one or more prompts to the machine-learning model that configure the machine-learning model to:
obtain vectorized content from the vectorized content repository in accordance with the first preference information such that the obtained vectorized content belongs to the first body of content;
generate first lesson content based on the obtained vectorized content belonging to the first body of content and the at least one of the one or more skills, wherein the first lesson content is generated to facilitate an improvement to the at least one of the one or more skills by the first user, responsive to the first user engaging with the first lesson content;
obtain output from the machine-learning model, wherein the output includes the first lesson content; and
provide the first lesson content to the first user.

2. The system of claim 1, wherein providing the one or more prompts to the machine-learning model configures the machine-learning model to obtain vectorized content from the vectorized content repository or one or more external repositories in accordance with the first preference information, wherein the one or more external repositories include vectorized content belonging to the one or more bodies of content, and wherein the first lesson content is generated based on vectorized content obtained from the one or more external repositories.

3. The system of claim 1, wherein the first preference information for the first user is based on user activity, by the first user, within a content streaming application, and wherein the first body of content preferred by the first user is determined based on content streamed by the first user or characteristics of the content streamed by the first user within the content streaming application.

4. The system of claim 1, wherein the first preference information for the first user is based on real-world experiences of the first user, wherein the first body of content is determined based on content associated with the real-world experiences of the first user.

5. The system of claim 1, wherein the one or more characteristics include themes, styles, genres, stories, characters, or a combination thereof.

6. The system of claim 1, wherein the first body of content includes vectorized content associated with a first character, and wherein the first lesson content includes the first character.

7. The system of claim 1, wherein the first body of content includes vectorized content associated with a first animation style, and wherein the first lesson content includes content in the first animation style.

8. The system of claim 1, wherein the first lesson content is interactive, wherein the first lesson content is presented to the first user via a user interface of a client computing platform associated with the first user, and wherein the client computing platform is configured to receive user input indicative of the first user engaging with the first lesson content.

9. The system of claim 1, wherein the response from the first user to the assessment includes verbal input, handwritten input, typed input, device input, or a combination thereof.

10. The system of claim 1, wherein the one or more physical processors are further configured by machine-readable instructions to:
effectuate presentation of the first lesson content to the first user;
receive a second response from the first user engaging with the first lesson content or in response to a second assessment provided after the first lesson content;
assess improvement of the one or more skills by the first user based on the second response; and
modify the one or more skills based on the assessed improvement.

11. The system of claim 10, wherein the one or more physical processors are further configured by machine-readable instructions to:
provide the modified one or more skills and the first preference information as additional input to the machine-learning model;
provide one or more additional prompts to the machine-learning model that configure the machine-learning model to:
generate second lesson content based on the obtained vectorized content belonging to the first body of content and at least one of the modified one or more skills, wherein the second lesson content is generated to facilitate an improvement to the at least one of the modified one or more skills by the first user;
obtain output from the machine-learning model, wherein the output includes the second lesson content; and
provide the second lesson content to the first user.

12. The system of claim 1, wherein the machine-learning model is comprised of a plurality of models configured to function cooperatively to output lesson content based on provided inputs.

13. The system of claim 1, wherein the one or more skills are associated with reading, reading comprehension, writing, speaking, math, or a combination thereof.

14. A method configured for generating personalized lesson content based on user content preferences, the method comprising:
storing user preference information for individual users, wherein the user preference information specifies one or more bodies of content preferred by the individual users, including storing first preference information for a first user specifying a first body of content;
storing, via a vectorized content repository, vectorized content belonging to the one or more bodies of content, wherein individual bodies of content include vectorized content sharing one or more characteristics, and wherein the vectorized content includes vectorized representations of text content, image content, video content, audio content, or a combination thereof;
providing an assessment to the first user;
receiving a response to the assessment from the first user;
identifying one or more skills that require improvement based on the response;
providing at least one of the one or more skills and the first preference information as input to a machine-learning model;
providing one or more prompts to the machine-learning model that configure the machine-learning model to:
obtain vectorized content from the vectorized content repository in accordance with the first preference information such that the obtained vectorized content belongs to the first body of content;
generate first lesson content based on the obtained vectorized content belonging to the first body of content and the at least one of the one or more skills, wherein the first lesson content is generated to facilitate an improvement to the at least one of the one or more skills by the first user, responsive to the first user engaging with the first lesson content;
obtaining output from the machine-learning model, wherein the output includes the first lesson content; and
providing the first lesson content to the first user.

15. The method of claim 14, wherein providing the one or more prompts to the machine-learning model configures the machine-learning model to obtain vectorized content from the vectorized content repository or one or more external repositories in accordance with the first preference information, wherein the one or more external repositories include vectorized content belonging to the one or more bodies of content, and wherein the first lesson content is generated based on vectorized content obtained from the one or more external repositories.

16. The method of claim 14, wherein the first preference information for the first user is based on user activity, by the first user, within a content streaming application, and wherein the first body of content preferred by the first user is determined based on content streamed by the first user or characteristics of the content streamed by the first user within the content streaming application.

17. The method of claim 14, wherein the first preference information for the first user is based on real-world experiences of the first user, wherein the first body of content is determined based on content associated with the real-world experiences of the first user.

18. The method of claim 14, wherein the one or more characteristics include themes, styles, genres, stories, characters, or a combination thereof.

19. The method of claim 14, wherein the first body of content includes vectorized content associated with a first character, and wherein the first lesson content includes the first character.

20. The method of claim 14, wherein the first body of content includes vectorized content associated with a first animation style, and wherein the first lesson content includes content in the first animation style.

21. The method of claim 14, wherein the first lesson content is interactive, wherein the first lesson content is presented to the first user via a user interface of a client computing platform associated with the first user, and wherein the client computing platform is configured to receive user input indicative of the first user engaging with the first lesson content.

22. The method of claim 14, wherein the response from the first user to the assessment includes verbal input, handwritten input, typed input, device input, or a combination thereof.

23. The method of claim 14, wherein the method further comprises:
effectuating presentation of the first lesson content to the first user;
receiving a second response from the first user engaging with the first lesson content or in response to a second assessment provided after the first lesson content;
assessing improvement of the one or more skills by the first user based on the second response; and
modifying the one or more skills based on the assessed improvement.

24. The method of claim 23, wherein the method further comprises:
providing the modified one or more skills and the first preference information as additional input to the machine-learning model;
providing one or more additional prompts to the machine-learning model that configure the machine-learning model to:
generate second lesson content based on the obtained vectorized content belonging to the first body of content and at least one of the modified one or more skills, wherein the second lesson content is generated to facilitate an improvement to the at least one of the modified one or more skills by the first user;
obtaining output from the machine-learning model, wherein the output includes the second lesson content; and
providing the second lesson content to the first user.

25. The method of claim 14, wherein the machine-learning model is comprised of a plurality of models configured to function cooperatively to output lesson content based on provided inputs.

26. The system of claim 14, wherein the one or more skills are associated with reading, reading comprehension, writing, speaking, math, or a combination thereof.
